(19) United States
(12) Patent Application Publication
(10) Pub. No.: US 2006/0144689 A1
(43) Pub. Date: Jul. 6, 2006

(54) Modular ozone generator

(75) Inventors: Steven R. Barnes, Phoenix, AZ (US); Richard D. Conn, Tempe, AZ (US)

Correspondence Address: C. Robert von Hellens, 155 Park One, 2141 E. Highland Avenue, Phoenix, AZ, 85016, US

(73) Assignee: PARAMOUNT LEISURE INDUSTRIES, INC.

(21) Appl. No.: 11/029,288

(22) Filed: Jan. 5, 2005

(51) Int. Cl. C01B 13/00; B01J 19/08; B01J 19/12

(52) U.S. Cl. 204/157.5; 422/186.3; 422/186.07

(57) ABSTRACT

A modular ozone generator includes an ultraviolet (UV) lamp within a chamber for converting some of the oxygen molecules in air to ozone molecules. The air is introduced through an inlet at a high point of the chamber and discharged through an outlet at a low point of the chamber to increase the percentage of ozone discharged due to the higher density ozone molecules migrating downwardly. A second or more ozone generator modules are beneath the first ozone generator module with an interlocking mechanism to align the outlet of an upper ozone generator with the inlet of a lower ozone generator module. The number of cascaded ozone generator modules forming a vertical stack is a function of the concentration (and amount) of ozone molecules sought to be generated. Readily removable end caps for each ozone generator module accommodate repair and replacement of any and all internal components with or without dismounting the ozone generator module from its supporting structure. Slidably mounted tabs accommodate attachment of the ozone generator modules to hard points of the supporting structure.

### BACKGROUND OF THE INVENTION

1. Field of the Invention

The present invention relates to ozone generators and, more particularly, to modular ozone generators particularly adapted for use in ozonating the air in the return line of a swimming pool or spa.

2. Description of Related Prior Art

All modem swimming pools and spas include a pump for recirculating the water through a filtration apparatus. The filtration apparatus filters and collects organic and inorganic matter suspended in the water passing through the filter. The micro-organisms that may be part of the organic matter are usually responsible for algae and other organic contaminations of the water in the swimming pool or spa. Conventional treatment procedures include mixing chemicals with the water in the swimming pool or spa to destroy the contaminating micro-organisms. Some of these chemicals may be hazardous to the health of a user of the swimming pool or spa for a period of time until the chemicals have dissipated or otherwise been rendered impotent.

The injection of ozone into water to kill micro-organisms is part of a procedure that has been carried out for decades. Usually, such ozone injection is used in conjunction with waste water treatment plants. Other installations requiring sterile water have also used ozone entraining apparatus in an attempt to destroy any micro-organisms present. There have been some instances of injecting ozone into the return line of swimming pools and spas but for the most part, such installations have not been functionally or practically successful. The main reason for lack of success relates to the low concentration of ozone in the air injected, which required significant amounts of ozone enriched air. Such large amounts of ozone enriched air tended to cause cavitation at the impeller of the pump drawing water through the return line. Additionally, air would tend to collect within the filter and compromise the rate of water flow and the filtration process.

Existing apparatus for injecting ozone enriched air into the return line from a swimming pool or spa tends to be sized as a function of the amount of ozone to be injected per unit of time. To increase the amount of ozone enriched air injected generally required different or larger sized units and hence such replacement incurs a significant cost.

### SUMMARY OF THE INVENTION

A modular ozone generator includes a tubular lamp disposed within a chamber for emitting radiation in the ultraviolet frequency range to cause conversion of some of the oxygen molecules within the chamber into ozone molecules. Air inflows into the chamber through an inlet at the upper part of the chamber. During irradiation of the oxygen molecules, the resulting ozone molecules will migrate downwardly within the chamber as the ozone molecules are heavier than the oxygen molecules. This results in a higher concentration of ozone molecules at the bottom of the chamber. To take advantage of the increased concentration of ozone molecules in the air at the lower part of the chamber, an outlet is formed therein. When two or more modules are used, the second module is placed beneath the first module to align its inlet with the outlet of the first module. Thereby, the air with the higher concentration of ozone molecules enters the second module wherein the concentration of ozone molecules is further enhanced. Where a yet higher concentration of ozone molecules is desired for a particular application, further modules may be stacked downwardly. Thereby, a selected number of modules may be employed at each location as a function of the concentration of ozone molecules desired to be entrained within the water to be treated. Each module includes keyways at the top and bottom for slidably receiving tabs to secure the uppermost and lowermost modules to a supporting structure. Keys engage the keyways facing one another between the modules to interconnect adjacent modules. Detachably attached end caps accommodate repair/replacement of elements within a module without requiring dismounting of a module from its support and eliminate detachment of one module from another for such purposes.

### BRIEF DESCRIPTION OF THE DRAWINGS

The present invention will be described with greater specificity and clarity with reference to the following drawings, in which:

FIG. 1 is an isometric view of a pair of stacked modular ozone generators;

FIG. 2 is a cross-sectional view taken along lines 2-2, as shown in FIG. 1;

FIG. 3 is a partial cross-sectional view illustrating the mounting of a tubular lamp within each module;

FIG. 4 is a partial exploded view showing the inlets and outlets of the respective modules;

FIG. 5 is a partial exploded view illustrating the detachably attached end caps and lamp supporting ribs;

FIG. 6 is a cross-sectional view taken along line 6-6, as shown in FIG. 3; and

FIG. 7 is a cross-sectional view taken along line 7-7, as shown in FIG. 6.

### DESCRIPTION OF THE PREFERRED EMBODIMENT

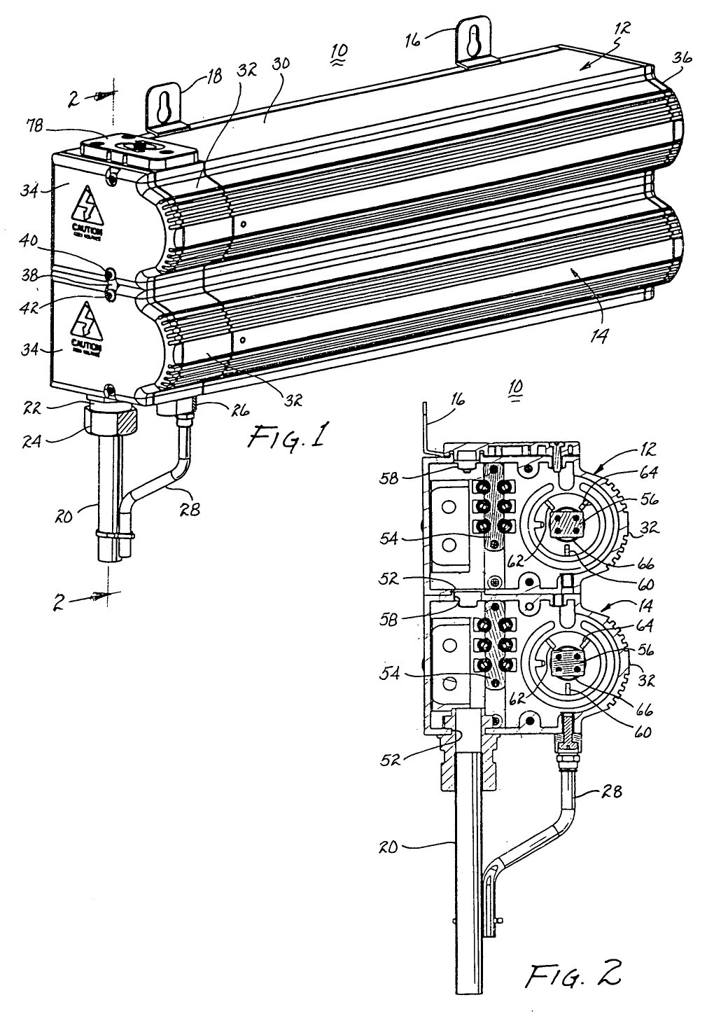

Referring to FIG. 1, there is illustrated an ozone generator 10 formed of a first module 12 and a second module 14. Each of these modules constitutes an ozone generator. Upon actuation, each module will generate ozone enriched air for discharge at its outlet. By cascading the modules, as illustrated in FIG. 1, the degree of concentration of ozone in the air ultimately discharged from ozone generator 10 will be enhanced.

Each ozone generator 10 is primarily intended for use with a swimming pool or spa. Depending upon the amount of water in the pool or spa, one or more modules (12, 14) may be used to ensure an effective degree of entrainment of the ozone in the water to ensure oxidization of organic material that may be present. In particular, it is intended that the ozone, upon coming in contact with micro-organisms, destroys such micro-organisms.

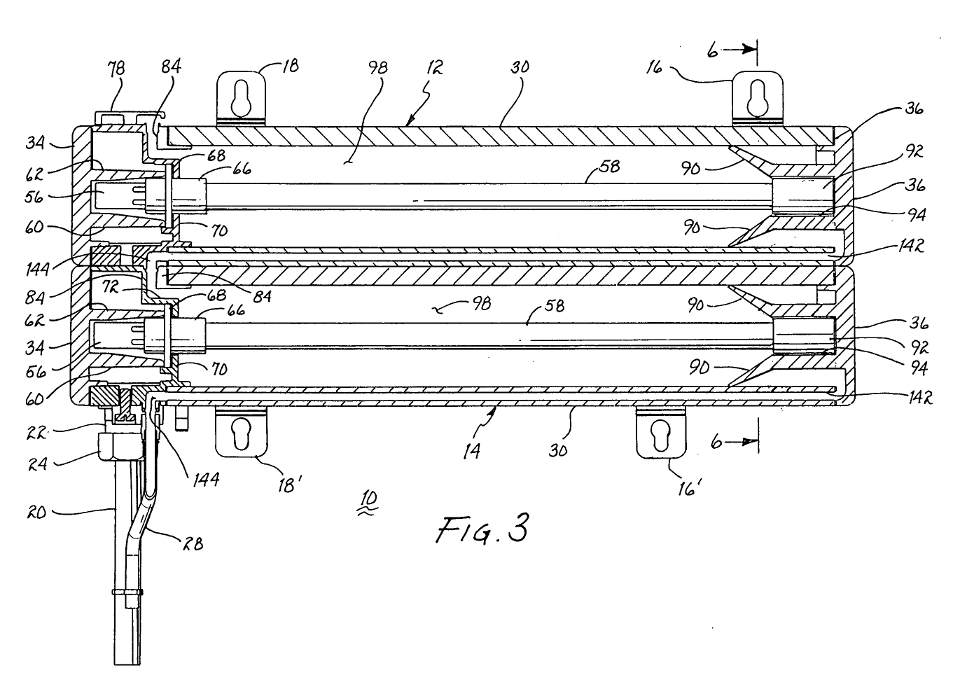

Still referring primarily to FIG. 1, an overall description of ozone generator 10 will be provided. A pair of tabs 16, 18 are slidably mounted at the rear of module 12 to permit positioning of the tabs in conformance with hard points of a support or supporting structure. A similar pair of tabs 16′ and 18′ extend downwardly from the lower-most module (module 14, as shown in FIG. 3). Electrical power to the circuitry and lamps disposed in each of modules 12 and 14 is housed within a conduit 20 secured to a fitting 22 by a nut 24, in accordance with conventional practice. The ozone enriched air is discharged from module 14 through a fitting 26 into a pipe or tube 28.

Each of modules 12 and 14 includes a body 30, which is preferably a hollow aluminum extrusion having a cross-sectional configuration to be described below. A section 32, having the same exterior configuration as body 30, is attached to the body and houses the electrical circuitry for a lamp along with a socket for the lamp. Additionally, it includes the channels for channeling a gas, such as air, into body 30 and further channels for channeling the ozone enriched air out of the body. An end cap 34 seals the exposed end of section 32. A further end cap 36 seals the corresponding end of body 30. A strap 38 is lodged within mating depressions 40 at the bottom edge of end cap 34 of module 12 and depression 42 at the upper edge of lower end cap 34 formed as part of module 14. Attachment means, such as screws or bolts 74, 76, extend through apertures in depressions 40, 42 for engagement with body 30 to retain end cap 34 and section 32 attached to the body.

Referring jointly to FIGS. 2, 3 and 4, further details will be described. As modules 12 and 14 are essentially identical, common reference numerals will be used for common elements. Fitting 22, in combination with nut 24 and conduit 20 comprise common off-the-shelf fitting assemblies used to interconnect electrical conduit 20 with an aperture 52 at the bottom of section 32 of module 14. Thereby, electrical conductors extend from within conduit 20 to a terminal board 52 within section 32. Further conductors extend from terminal board 52 in section 36 of module 14 to terminal board 54 within section 32 of module 12 through an aperture 58 at the top of the section and aperture 52 in section 32 of module 12. Further electrical conductors extend from each terminal board 54 and are connected to lamp plug 56 in each respective module. Thereby, electrical power is provided to each of lamps 58 particularly shown in FIG. 3.

Each section 32 includes a plurality of inwardly extending radially oriented ribs 60, 62 and 64 for supporting and centrally orienting base 66 of each respective lamp 58. These ribs may be tapered toward the lamp base, as shown in FIG. 3. The base of each lamp includes an annular flange 68 that bears against a wall 70 of section 32 and within a cylindrical section 72 after penetrable insertion of the lamp through an aperture 73 in the wall, which wall serves as a mounting for said lamp. The lamp is retained thereagainst by ribs 60, 62 and 64. Attachment means, such as bolts 74, 76 penetrably engage strap 38 and are in threaded engagement with corresponding channels 108, 110 in body 30 (see FIG. 5). Thereby, the strap serves to tie module 12 with module 14.

Further bolt 76 of module 12 and further bolt 74 of module 14 also engage corresponding channels in body 30 and further secure end caps 34 and sections 32 to their respective body 30. A cover 78 and gasket 80 is secured by a plurality of bolts 82 to section 32 of uppermost module 12. The purpose of this cover is to seal aperture 58 at the top of section 32 of module 12 and to shield but not cover inlet 84 within section 32 (see FIG. 3). Thereby, the interior of section 32 is sealed and water and other foreign matter is discouraged from flowing into inlet 84.

Referring jointly to FIGS. 3 and 5, end cap 36 and its function, as well as its cooperation with the corresponding end of body 30 will be described. The end cap includes a plurality of ribs 90 extending toward body 30 for receiving and guiding end 92 of lamp 58 into a socket 94. Thereby, insertion of a replacement lamp is readily performed by simply removing end cap 34, withdrawing the lamp and inserting a replacement through aperture 73 in wall 70. As end 92 of the lamp approaches end cap 36, it will be guided into its socket and little skill to install the lamp is required by a workman. A gasket 96 is disposed intermediate end cap 36 and body 30 to maintain the integrity of chamber 98 within the body.

Further gaskets provide a seal between end cap 34 and section 32 and between section 32 and body 30. When two or more modules are employed, a mechanical structural interconnection therebetween is provided by a further strap 100 (like strap 38) nesting within depressions 102 and 104 in the respective end caps. Attachment means, such as bolt 106, penetrably engages strap 100 through an aperture extending inwardly from within depression 102 and into threaded engagement with channel 108 formed as part of bodies 30. This same channel is threadedly engaged by bolt 74 extending through end cap 34 and section 32 at the other end of module 12. Similarly, a bolt 107 penetrably engages strap 100 and extends through an aperture formed as part of depression 104 into threaded engagement with a channel 110 disposed in body 30 of module 12. This same channel is engaged by bolt 76 exxtending through end cap 34 and section 32 at the other end of the module 14. A further bolt 109 penetrably engages depression 104 and the aperture therein at the upper edge of end cap 36 corresponding with module 12 into threaded engagement with channel 110. This channel is similarly engaged by a bolt 74 extending through end plate 34 and section 32 at the other end of module 12. This same channel is engaged by bolt 76 extending through end cap 34 and section 32 at the other end of module 12. A yet further bolt 112 penetrably engages depression 102 and the aperture therein at the lower edge of end plate 36 corresponding with module 14 into threaded engagement with channel 108. This same channel is engaged by bolt 74 extending through end cap 34 and section 32 at the other end of module 14.

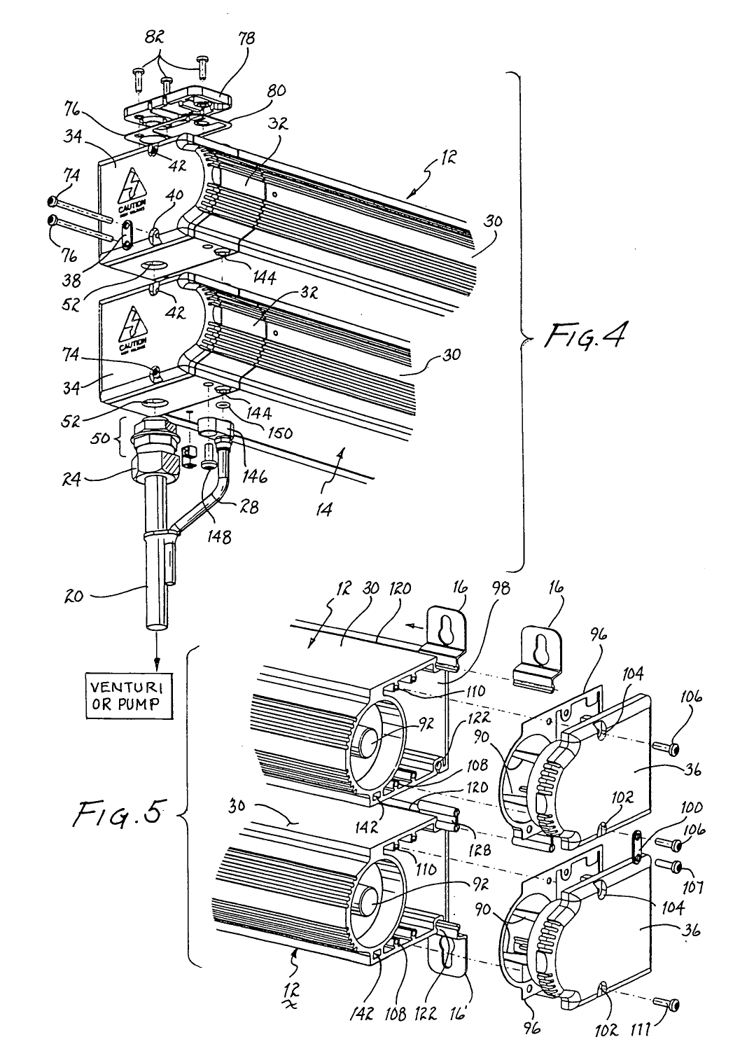

Referring jointly to FIGS. 3, 5, 6 and 7, further interconnections between adjacent modules will be described along with further details attendant mounting of the module or a set of modules to a support or supporting surface. A keyway 120 extends along the top rear edge of body 30. A similar keyway 122 extends along the bottom rear edge of the body. Tab 16 includes an apertured flat segment 124 for penetrably receiving attachment means, such as a screw, bolt, nail, or the like, for securing the tab and the supported module to a supporting surface. The lower end of tab 16 includes a bulbous segment 126 slidably disposed within keyway 120. This bulbous segment may be a partial circular segment bent from a part of a sheet of material forming tab 16, as illustrated. Thereby, the tab may be slidably moved along keyway 120 to position it in correspondence with a hard point of the supporting surface. A key 128, shaped in the manner of a dog bone in cross section, includes opposed bulbous ends 130, 132 for slidable engagement within keyway 130 in module 12 and keyway 120 in module 14. The distance between the bulbous ends is configured to ensure that module 14 is captured adjacent to and in contacting relationship with module 12. Thereby, key 128 (or keys 128), in combination with straps 38, 100 (see FIGS. 4 and 5) provide a mechanical interconnection between modules 12 and 14 to maintain the modules adjacent one another to form a unitary structure. It may be noted that bulbous ends 130, 132 of key 128 are shown as cylindrical elements and may be an extrusion aluminum. Alternatively, the bulbous ends may be solid.

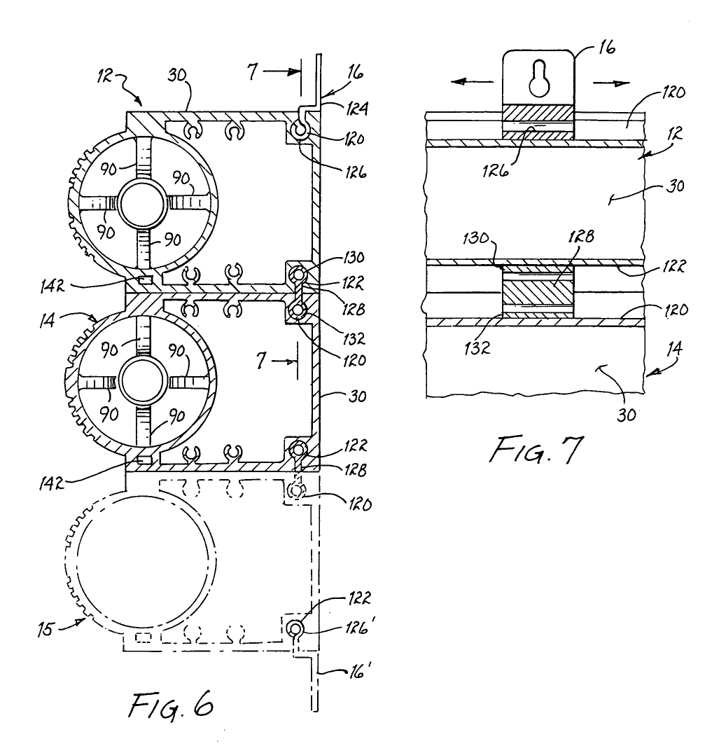

FIG. 6 illustrates a yet further module 15 identical with modules 12 and 14. The purpose of this illustration, in dashed lines, is that of representing further and possibly multiple modules identical with modules 12 and 14 and stacked therebelow. As each module not only produces additional ozone molecules but also increases the concentration of ozone molecules within the air, the number of modules employed would be a function of not only the amount of water to be ozonated but the flow rate and entrainment rate of the ozone molecules in the water. FIG. 6, as well as FIG. 3, also illustrate further tabs 16′ and 18′ which are identical with tabs 16 and 18. Bulbous segment 126′ of each of tabs 16′ and 18′ slidably engages keyway 122 in module 15. Obviously, if only module 12 or only modules 12 and 14 were employed, tabs 16′ and 18′ would engage the keyway 122 of the lowermost module.

Referring primarily to FIGS. 3 and 4, the step of ozone generation and the steps of conveying the ozonated air through and discharge it from ozone generator 10 will be described. Air is drawn in through inlet 84 of module 12 into chamber 98 of module 12. The air within the chamber is irradiated by ultraviolet (UV) light emanating from lamp 58. Such irradiation will convert some of the oxygen molecules into ozone molecules. As particularly shown in FIG. 3, inlet 84, shielded by cover 78, is formed within section 32. The flow of air within chamber 98 from the inlet traverses the length of lamp 58 to expose the flowing air to the full length of the lamp and thereby increase the creation of ozone molecules. At the far end of the module, the air flows intermediate ribs 90 and into a passageway 142 extending the length of body 30 beneath chamber 98. The ozonated air flows from passageway 142 into section 32 wherein it is directed downwardly through an outlet 144 in an upper section 32 and into an inlet 84 of a lower section 32; O-rings or the like are used to seal the junction between the outlets and the inlets to prevent escape of any ozonated air. It is noted that inlet 84 of module 12 is identical with inlet 84 of module 14. The air is directed from inlet 84 of module 14 into chamber 98 of the module. This air includes ozone molecules created in module 12. Further exposure to lamp 58 in module 14 will produce further conversion of oxygen molecules into ozone molecules. Again, the ozone enriched air within module 14 will flow along lamp 58 into passageway 142 of module 14. The ozone enriched air in channel 142 of module 14 is exhausted through outlet 144 in module 14.

As particularly shown in FIG. 4, a fitting 146 is secured to section 32 with a bolt 148. The purpose of fitting 146 is that of interconnecting tube 28 with outlet 144 at the bottom of section 32 of module 14. An O-ring 150 is disposed between fitting 146 and section 32 to ensure a leak free interconnection between tube 28 and outlet 144. It is to be noted that further O-rings 150 or similar sealing members may be disposed between the outlet of one module and the inlet of an adjacent module to provide a leak free interconnection.

Ozone molecules are more dense and hence heavier than oxygen modules. This physical attribute of these molecules is purposely used in the present invention to increase the concentration of ozone molecules in the ozone enriched air discharged from each module and from a set of modules forming the ozone generator. More specifically, the ozone molecules created within module 12 will tend to migrate downwardly within chamber 98. Thus, the downward migration and hence concentration of ozone molecules at the bottom of the chamber will be greater than at the height upwardly therefrom. This greater concentration of ozone molecules will flow into passageway 142 and be discharged into chamber 98 of module 14. Again, the ozone molecules entering chamber 98 of module 14 and the further ozone molecules created therein will migrate downwardly to increase the concentration at the bottom of chamber 98 in module 14. Thereby, the concentration of ozone molecules in the air flowing into passageway 142 of module 14 and into tube 28 will be enhanced.

The flow of air through ozone generator 10, whether formed of a single module or of a multiple stacked molecules to provide a cascade-like creation of ozone molecules, may be induced by a venturi-like device 152 (see FIG. 4) having water flowing therethrough to create a low pressure environment to draw the ozone enriched air into entrainment in the water. This technology is well known. Alternatively, a pump 152 may be used to draw air through the ozone generator and entrain it within water through a sparger or the like.

We claim:

1. An ozone generator for providing ozone enriched air, said ozone generator comprising in combination:
a) a body for defining a chamber for air flow therethrough;
b) an ultraviolet lamp disposed in said chamber for irradiating the air passing through said chamber to convert oxygen molecules to ozone molecules;
c) an air inlet for introducing air at an upper part of said chamber; and
d) an air outlet at the lower part of said chamber for discharging ozone enriched air.

2. The apparatus as set forth in claim 1 wherein said inlet is at one end of said chamber and including a passageway disposed within said body for conveying the ozone enriched air from the other end of said chamber to said outlet.

3. The apparatus as set forth in claim 2 wherein said lamp is tubular and wherein said inlet is disposed proximate one end of said lamp and ingress to said channel is disposed proximate the other end of said lamp.

4. The apparatus as set forth in claim 1, including:
a) a section secured to one end of said body, said section including said inlet and said outlet, and a mounting for said lamp;
b) a first end cap secured to said section; and
c) a second end cap secured to said body.

5. The apparatus as set forth in claim 4, including a first channel extending for the length of said body adjacent the upper interior surface of said body, a second channel extending for the length of said body adjacent the lower interior surface of said body, first attachment means extending through said first end cap and said section for engaging said first and second channels and second attachment means extending through said second end cap for engaging said first and second channels.

6. The apparatus as set forth in claim 4, including a conduit extending from said section for housing electrical conductors adapted for providing electricity to said lamp to energize said lamp.

7. The apparatus as set forth in claim 1, including at least one first tab disposed at the top of said body and adapted for supporting said ozone generator from a supporting surface, a first keyway extending along the top of said body for slidably receiving and retaining each of said at least one first tabs, at least one second tab disposed at the bottom of said body and adapted for supporting said ozone generator from a supporting surface, a second keyway extending along the bottom of said body for slidably receiving and retaining each of said at least one second tabs.

8. The apparatus as set forth in claim 1, including tabs adapted for slidable engagement with each of the upper and lower surfaces of said body for attachment to a supporting surface and to mount said ozone generator on the supporting surface.

9. An ozone generator formed of interconnected stacked ozone generating modules, each module comprising in combination:
a) a body, a section disposed at one end of said body, a first end cap secured to said section, and a second end cap secured to the other end of said body, said section and said first and second end caps defining a chamber within said module;
b) an ultraviolet lamp disposed within said chamber for converting oxygen molecules into ozone molecules;
c) an inlet in fluid communication with the top of said chamber for introducing air into said chamber;
d) an outlet in fluid communication with the bottom of said chamber for discharging ozone enriched air from said chamber, said outlet of an upper one of said modules being in fluid communication with said inlet of an adjacent lower one of said modules; and
e) a tube extending from said outlet of the lowermost one of said modules to a point of use of the ozone enriched air.

10. The apparatus as set forth in claim 9 wherein said lamp is a tubular lamp and wherein said inlet is disposed proximate one end of said lamp, including a passageway disposed in said body for conveying ozone enriched air from proximate the other end of said lamp to said outlet.

11. The apparatus as set forth in claim 9 wherein said second end cap includes a socket for receiving one end of said lamp and a plurality of ribs for guiding said lamp into said socket.

12. The apparatus as set forth in claim 9 wherein said section includes a mounting for mounting one end of said lamp.

13. The apparatus as set forth in claim 12 wherein said second end cap includes a socket for receiving the other end of said lamp and a plurality of ribs for guiding said lamp into said socket.

14. The apparatus as set forth in claim 12 wherein said section includes a mounting for said lamp and said first end cap includes prongs for retaining said lamp in said mounting.

15. The apparatus as set forth in claim 13 wherein said section includes a mounting for said lamp and said first end cap includes prongs for retaining said lamp in said mounting.

16. The apparatus as set forth in claim 9, including a conduit extending from the lowermost one of said modules and adapted for housing electrical conductors connected to each of said lamps.

17. A method for generating ozone enriched air, said method comprising the steps of:
a) introducing air through an inlet at the upper end of a chamber,
b) irradiating the air within the chamber with an ultraviolet lamp;
c) discharging the ozone enriched air through an outlet at the bottom of the chamber;
d) said step of introducing including the step of introducing the air through the inlet proximate one end of the lamp; and
e) said step of discharging including the step of conveying the ozone enriched air from the other end of the lamp through a passageway to the outlet.

18. The apparatus as set forth in claim 17, including the step of conveying the ozone enriched air from the outlet through a tube to a point of use.

19. The apparatus as set forth in claim 17 wherein said steps of a, b, c, d and e are carried out in each of a first and second module and including the steps of:
a) securing the first module to the top of the second module to form a unitary ozone generator; and
b) channeling the ozone enriched air from the outlet of the first module to the inlet of the second module.

20. The apparatus as set forth in claim 19 wherein each of the modules includes a body defining a chamber, a section disposed adjacent one end of the body, a first end cap disposed adjacent the section and a second end cap disposed adjacent the other end of the body, including the steps of:
a) locating one end of the lamp in the section;
b) retaining the other end of the lamp in a socket in the second end cap; and
c) sealing the ends of the chamber with the first and second end caps.

21. The apparatus as set forth in claim 20, including the step of mounting the one end of the lamp in the section with the first end cap.

22. The apparatus as set forth in claim 21, including the step of guiding the other end of the lamp into the socket with ribs during insertion and replacement of the lamp.

23. The apparatus as set forth in claim 19, including a first and second keyway disposed along the top and the bottom, respectively, of each of the modules and including the steps of:
a) slidably engaging at least one tab with the first keyway in the first module to accommodate attachment of the first module to a supporting surface; and
b) slidably engaging at least one tab with the second keyway in the second module to accommodate attachment of the second module to the supporting surface.

24. The apparatus as set forth in claim 23, including the step of slidably engaging a key with the second keyway in the first module and with the first keyway in the second module to interconnect the first and second modules.

25. The apparatus as set forth in claim 20, including the step of attaching the first end cap of the first module and the first end cap of the second module with a first strap and the step of further attaching the second end cap of the first module and the second end cap of the second module with a second strap.
